(19) United States
(12) Patent Application Publication
(10) Pub. No.: US 2026/0280366 A1
(43) Pub. Date: Sep. 17, 2026

(54) ROTATING ELECTRIC MACHINE AND METHOD OF ASSEMBLING ROTATING ELECTRIC MACHINE

(71) Applicant: HONDA MOTOR CO., LTD., Tokyo (JP)

(72) Inventor: Keiichi Ohiso, Wako-shi (JP)

(21) Appl. No.: 19/560,662

(22) Filed: Mar. 9, 2026

(30) Foreign Application Priority Data
Mar. 11, 2025 (JP) 2025-038071

(51) Int. Cl. H02K 1/20; H02K 1/18; H02K 15/028; H02K 21/22

(52) U.S. Cl. CPC H02K 1/20; H02K 1/187; H02K 15/028; H02K 21/22

(57) ABSTRACT

A rotating electric machine includes a stator, a stator holding member that holds the stator, and a conduit member disposed between the stator and the stator holding member. A first recess is provided in a surface of the stator that faces the stator holding member. A second recess facing the first recess is provided in the stator holding member. The conduit member is disposed in an arrangement hole formed by the first recess and the second recess.

### CROSS-REFERENCE TO RELATED APPLICATIONS

This application is based upon and claims the benefit of priority from Japanese Patent Application No. 2025-038071 filed on Mar. 11, 2025, the contents of which are incorporated herein by reference.

### BACKGROUND OF THE INVENTION

### Field of the Invention

The present disclosure relates to a rotating electric machine and a method of assembling a rotating electric machine.

### Description of the Related Art

In the rotating electric machine disclosed in JP H07-049780 B, a cooling conduit member is disposed between a stator and a case serving as a stator holding member. The cooling conduit member is disposed in a cutout portion (groove) provided in the outer peripheral portion of the stator.

### SUMMARY OF THE INVENTION

In the above-described conventional technique, a positioning member for performing positioning between the stator and the stator holding member in the circumferential direction is separately required, and the number of components increases accordingly.

The present disclosure has the object of solving the above-described problem.

A first aspect of the present disclosure is characterized by a rotating electric machine comprising: a stator; a stator holding member facing the stator in a radial direction and configured to hold the stator; and a conduit member which is disposed between the stator and the stator holding member and through which a coolant for cooling the stator passes, wherein a first recess is provided in a surface of the stator that faces the stator holding member, a second recess facing the first recess is provided in the stator holding member, and the conduit member is disposed in an arrangement hole formed by the first recess and the second recess.

A second aspect of the present disclosure is characterized by a method for assembling a rotating electric machine that includes a stator, a stator holding member configured to hold the stator, and at least two conduit members through which a coolant for cooling the stator passes, the method comprising: a first mounting step of respectively mounting the at least two conduit members in at least two second semicircular grooves provided in a peripheral surface of the stator holding member; and a second mounting step of, after the first mounting step, mounting the stator to the stator holding member in a manner so that the stator and the stator holding member face each other in a radial direction, wherein, in the first mounting step, first end portions of the conduit members are respectively press-fitted into at least two fixing holes provided in the stator holding member, and in the second mounting step, the conduit members are respectively inserted into at least two first semicircular grooves provided in a peripheral surface of the stator, and the stator is fitted to the stator holding member below end surfaces of second end portions of the conduit members, the second end portions being located on a side opposite to the first end portions.

According to the present disclosure, the conduit member also serves as a member for performing positioning between the stator and the stator holding member in the circumferential direction, and therefore the number of components can be reduced and the positioning structure can be simplified.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a cross-sectional view of a rotating electric machine according to an embodiment of the present disclosure (a cross-sectional view taken along line I-I in FIG. 3);

FIG. 2 is a cross-sectional view taken along line II-II in FIG. 3;

FIG. 3 is a cross-sectional view taken along line III-III in FIG. 1;

FIG. 4A is a first diagram explaining a method of assembling the rotating electric machine;

FIG. 4B is a second diagram explaining the method of assembling the rotating electric machine;

FIG. 5A is a third diagram explaining the method of assembling the rotating electric machine;

FIG. 5B is a fourth diagram explaining the method of assembling the rotating electric machine;

FIG. 6A is a diagram showing a first configuration example for preventing erroneous assembly; and

FIG. 6B is a diagram showing a second configuration example for preventing erroneous assembly.

### DETAILED DESCRIPTION OF THE INVENTION

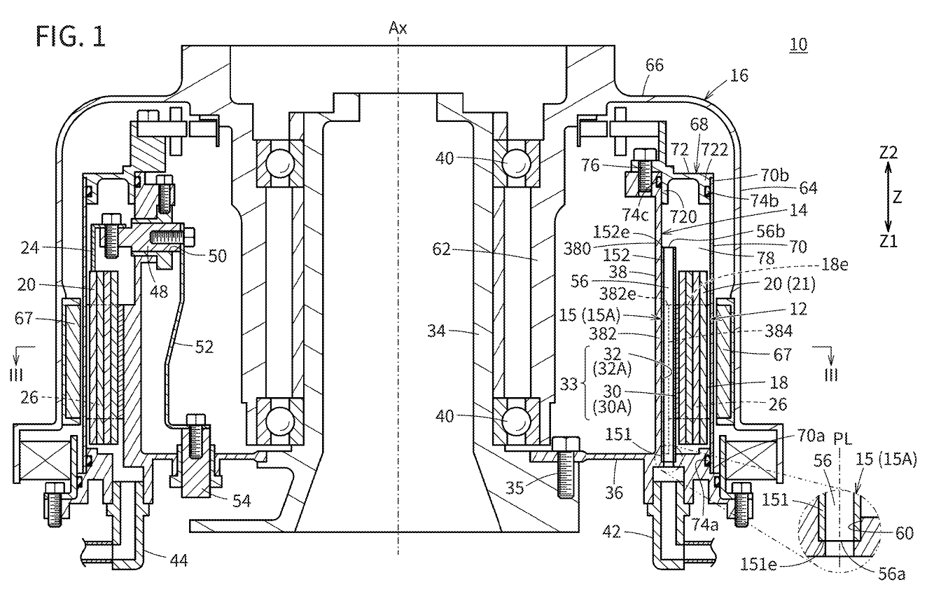

As shown in FIG. 1, a rotating electric machine 10 according to the present embodiment includes a stator 12, a stator holding member 14, a conduit member 15, and a rotor 16. The rotating electric machine 10 may be a motor or a generator. In the following description, the axis Ax is common to the rotating electric machine 10, the stator 12, the stator holding member 14, and the rotor 16. Regarding the rotating electric machine 10 and the components thereof (the stator 12, the stator holding member 14, and the rotor 16), a direction extending along the axis Ax (Z direction) is referred to as an "axial direction", a direction extending along a circle centered on the axis Ax is referred to as a "circumferential direction", and a direction orthogonal to the axis Ax is referred to as a "radial direction". In the axial direction, one direction (Z1 direction) is referred to as a "first direction", and the other direction (Z2 direction) is referred to as a "second direction".

The stator 12 is formed in a hollow cylindrical shape. The stator 12 includes a stator core 18, an electromagnetic coil 20, and an electrical connection member 24. The stator core 18 is formed in a hollow cylindrical shape. The stator core 18 is fitted to the outer peripheral surface of the stator holding member 14. The inner peripheral surface of the stator core 18 is in contact with the outer peripheral surface of the stator holding member 14. The stator core 18 includes a plurality of slots 26 extending in the axial direction. The plurality of slots 26 are formed at intervals in the circumferential direction.

The electromagnetic coil 20 is inserted into the plurality of slots 26. The electromagnetic coil 20 is constituted by, for example, a plurality of segment coils 21 stacked in the radial direction. The electromagnetic coil 20 includes a U-phase coil, a V-phase coil, and a W-phase coil. The electrical connection member 24 is connected to the electromagnetic coil 20. Three electrical connection members 24 are provided corresponding to the U-phase, V-phase, and W-phase coils.

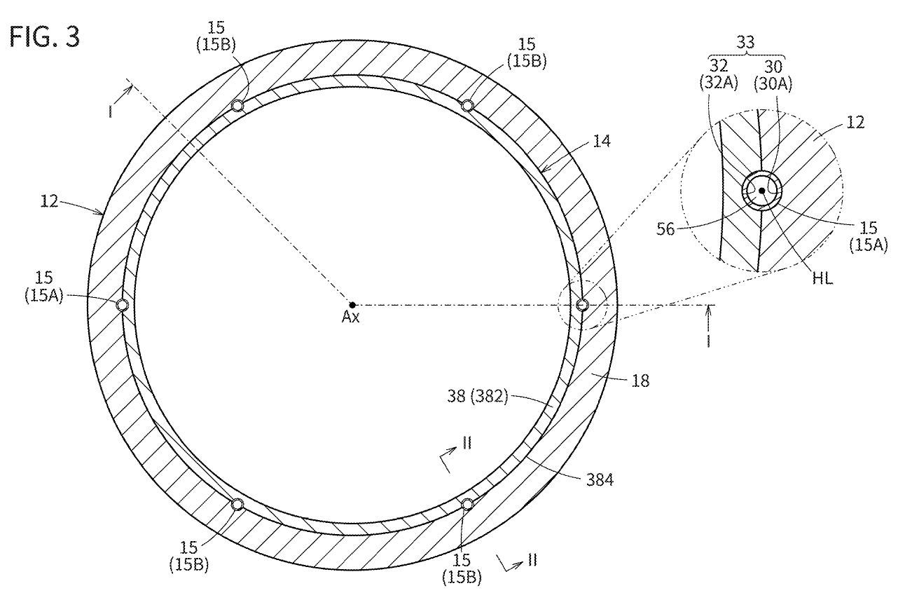

As shown in FIG. 3, a first recess 30 is provided in a surface of the stator 12 that faces the stator holding member 14. Specifically, a plurality of the first recesses 30 are provided in the inner peripheral portion of the stator core 18 at intervals in the circumferential direction. Each of the first recesses 30 is a semicircular groove. Hereinafter, the first recess 30 is also referred to as a "first semicircular groove 30A". The plurality of first semicircular grooves 30A are arranged at equal intervals in the circumferential direction.

As shown in FIG. 1, the stator holding member 14 holds the stator 12. The stator holding member 14 faces the stator 12 in the radial direction. The stator 12 is press-fitted to the outer peripheral surface of the stator holding member 14. The stator holding member 14 includes a holding base portion 36 and a holding body portion 38. The holding base portion 36 is supported by a shaft member 34. The holding base portion 36 is fixed to the shaft member 34 by a bolt 35. The shaft member 34 extends along the axial direction. Two bearings 40 are held on the shaft member 34 with a space therebetween in the radial direction.

The holding base portion 36 protrudes radially outward from an end portion of the shaft member 34 on the Z1 direction side. A first connection pipe 42 is connected to the holding base portion 36. A plurality of the first connection pipes 42 are provided at intervals in the circumferential direction. The first connection pipe 42 is, for example, an inlet pipe for introducing a coolant into the rotating electric machine 10. A second connection pipe 44 is connected to the holding base portion 36. The second connection pipe 44 is, for example, an outlet pipe for discharging the coolant from the rotating electric machine 10. Note that the first connection pipe 42 may be an outlet pipe, and the second connection pipe 44 may be an inlet pipe.

The holding body portion 38 protrudes in the Z2 direction from the holding base portion 36. The holding body portion 38 surrounds the shaft member 34 and is disposed to be spaced apart from the shaft member 34 in the radial direction. The holding body portion 38 includes a small-diameter portion 380 and a large-diameter portion 382. The small-diameter portion 380 is adjacent to the large-diameter portion 382 on the Z2 direction side. The outer diameter of the small-diameter portion 380 is smaller than the outer diameter of the large-diameter portion 382. The large-diameter portion 382 protrudes in the Z2 direction from the holding base portion 36. The outer peripheral surface of the large-diameter portion 382 is a holding surface 384 (fitting surface) that holds the stator core 18.

As shown in FIG. 3, a second recess 32 facing the first recess 30 is provided in the stator holding member 14. Specifically, in the stator holding member 14, a plurality of the second recesses 32 are provided in the outer peripheral surface of the large-diameter portion 382 of the holding body portion 38 at intervals in the circumferential direction. Each of the second recesses 32 is a semicircular groove. Hereinafter, the second recess 32 is also referred to as a "second semicircular groove 32A".

The plurality of second semicircular grooves 32A are arranged at equal intervals in the circumferential direction. The first recess 30 and the second recess 32 facing each other form an arrangement hole 33. The cross-sectional shape of the arrangement hole 33 formed by the first semicircular groove 30A and the second semicircular groove 32A is circular. A central axis HL of the arrangement hole 33 substantially coincides with the central axis of the conduit member 15. The arrangement holes 33 are provided at equal intervals in the circumferential direction. As shown in FIG. 1, the second semicircular groove 32A opens at an end surface 382e of the large-diameter portion 382 on the Z2 direction side.

The stator holding member 14 supports a connector 48 to which the electrical connection member 24 is connected. The connector 48 is a rod-shaped member inserted into a support hole 50 provided on the Z2 direction side of the stator 12, and is fixed to the holding body portion 38. The connector 48 is connected to a terminal member 54 via a conductive member 52 disposed inside the stator holding member 14.

The conduit member 15 is a member for passing therethrough a coolant for cooling the stator 12. The conduit member 15 is disposed between the stator 12 and the stator holding member 14. The conduit member 15 has a cylindrical shape. The conduit member 15 includes an inner flow path 56. The conduit member 15 is formed in a linear shape. The conduit member 15 is disposed along the axial direction (Z direction). A plurality of the conduit members 15 are disposed in the plurality of arrangement holes 33, respectively. Therefore, in the present embodiment, the plurality of conduit members 15 are arranged at equal intervals in the circumferential direction.

The conduit members 15 each include a first end portion 151 which is an end portion in the first direction (Z1 direction), and a second end portion 152 which is an end portion in the second direction (Z2 direction). A first opening 56a, which is one end of the inner flow path 56, is formed in an end surface 151e of the first end portion 151. The conduit member 15 communicates with the first connection pipe 42 via the first opening 56a.

The first end portion 151 is fixed to a fixing hole 60 provided in the stator holding member 14. The fixing hole 60 is a circular hole. The first end portion 151 is press-fitted into the fixing hole 60. That is, the fixing hole 60 is a so-called knock hole (dowel hole). Therefore, the first end portion 151 is press-fitted into the fixing hole 60 without backlash in the hole radial direction.

At least two fixing holes 60 are provided. In the present embodiment, the number of the fixing holes 60 is two. Hereinafter, among the plurality of conduit members 15, the conduit member 15 press-fitted into the fixing hole 60 is also referred to as a "first conduit member 15A", and the conduit member 15 other than the first conduit member 15A is also referred to as a "second conduit member 15B" (see FIG. 3). The fixing holes 60 are provided in the holding base portion 36 of the stator holding member 14. The fixing holes 60 are each provided concentrically with the first semicircular groove 30A and the second semicircular groove 32A on the Z1 direction side of the first semicircular groove 30A and the second semicircular groove 32A. A central axis PL of the first conduit member 15A coincides with the central axis of the fixing hole 60.

The second end portion 152 of the conduit member 15 protrudes in the axial direction from the end surface 382e of the large-diameter portion 382 in the Z2 direction. Therefore, the second end portion 152 protrudes in the Z2 direction from the first semicircular groove 30A. The second end portion 152 of the conduit member 15 protrudes further in the second direction than an end surface 18e of the stator core 18 in the Z2 direction. A second opening 56b, which is the other end of the inner flow path 56, is formed in an end surface 152e of the second end portion 152. The second opening 56b is open in the Z2 direction.

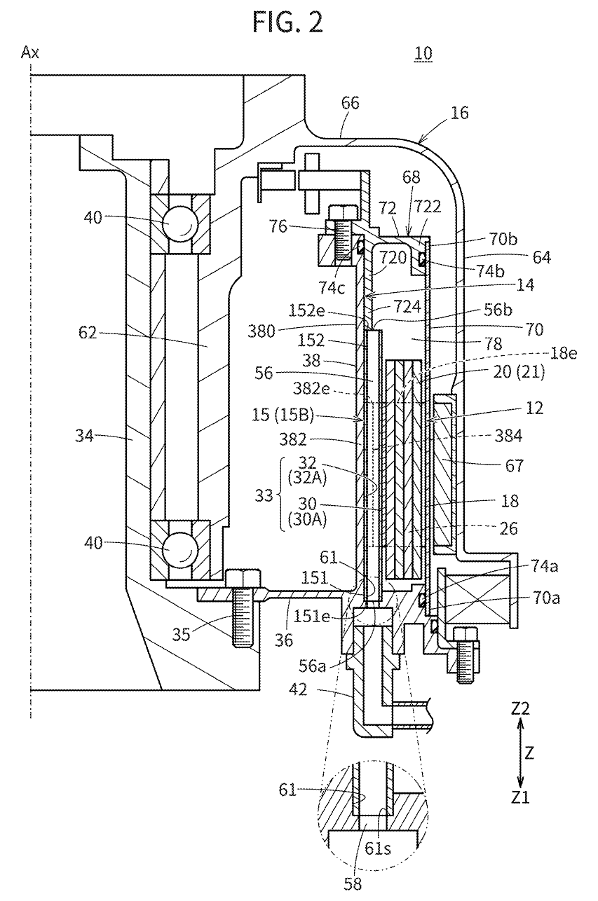

As shown in FIG. 2, the first end portion 151 of the second conduit member 15B is inserted into an insertion hole 61 provided in the stator holding member 14. The insertion hole 61 is a circular hole. The diameter of the insertion hole 61 is larger than the diameter of the fixing hole 60 (FIG. 1) and the outer diameter of the first end portion 151. Therefore, the first end portion 151 is loosely inserted into the insertion hole 61 with a slight backlash in the hole radial direction. In the present embodiment, a plurality of the second conduit members 15B are provided. Note that only one second conduit member 15B may be provided. The insertion hole 61 is provided on the Z1 direction side of the first semicircular groove 30A and the second semicircular groove 32A. In order to prevent the second conduit member 15B from being displaced in the axial direction, the insertion hole 61 includes a step 61s between the insertion hole 61 and a communication hole 58 adjacent to the insertion hole 61 on the Z1 direction side. That is, the insertion hole 61, which is a loose hole portion, is not provided up to the end surface of the stator holding member 14, but becomes a small-diameter hole from the middle, thereby supporting the second conduit member 15B toward the Z2 direction.

The rotor 16 is rotatably supported by the shaft member 34 via the bearings 40. The rotor 16 includes an inner cylinder 62 and an outer cylinder 64. The inner cylinder 62 is disposed between the shaft member 34 and the outer cylinder 64. The bearings 40 are disposed between the shaft member 34 and the inner cylinder 62. The outer cylinder 64 is continuous with the inner cylinder 62 via a connecting portion 66. The connecting portion 66 connects end portions of the inner cylinder 62 and the outer cylinder 64 in the Z2 direction. The outer cylinder 64 surrounds the holding body portion 38 and the stator 12. A plurality of permanent magnets 67 are fixed to the inner peripheral portion of the outer cylinder 64. The plurality of permanent magnets 67 face the stator 12 on the radially outer side of the stator 12.

As shown in FIG. 1, the rotating electric machine 10 further includes a cover member 68. The cover member 68 is supported by the stator holding member 14. In the present embodiment, the cover member 68 includes a sleeve 70 and a sleeve holder 72. The sleeve 70 has a hollow cylindrical shape surrounding the stator 12. An end portion 70a of the sleeve 70 in the Z1 direction is supported by the holding base portion 36 of the stator holding member 14.

A part of the holding base portion 36 is inserted into the end portion 70a of the sleeve 70. An annular seal member 74a is disposed between the holding base portion 36 and the end portion 70a of the sleeve 70. An end portion 70b of the sleeve 70 in the Z2 direction is supported by the sleeve holder 72. An annular seal member 74b is disposed between the end portion 70b of the sleeve 70 and the sleeve holder 72.

The sleeve holder 72 is fixed to the stator holding member 14 (an end portion of the holding body portion 38 in the Z2 direction) by a fastening member 76 such as a bolt. An annular seal member 74c is disposed between the sleeve holder 72 and the holding body portion 38. The sleeve holder 72 includes a holder base portion 720 and a sleeve support portion 722. The holder base portion 720 is disposed outside the end portion of the holding body portion 38 in the Z2 direction.

The holder base portion 720 is spaced apart from the second end portion 152 of the first conduit member 15A in the axial direction. The sleeve support portion 722 protrudes radially outward from the holder base portion 720. The end portion 70b of the sleeve 70 is supported by the outer peripheral surface of the sleeve support portion 722. The sleeve support portion 722 is inserted into the sleeve 70.

As shown in FIG. 2, the sleeve holder 72 further includes a conduit support portion 724 that supports the second conduit member 15B. The conduit support portion 724 protrudes in the Z1 direction from the holder base portion 720. The conduit support portion 724 is in contact with the end surface 152e of the second conduit member 15B. As a result, the conduit support portion 724 prevents the second conduit member 15B from being displaced in the axial direction.

A cover inner space 78 constituting a part of a flow path for the coolant is formed between the stator holding member 14, the stator 12, and the cover member 68. The second opening 56b formed in the second end portion 152 of the conduit member 15 communicates with the cover inner space 78. The coolant may be a liquid or a gas. The coolant may be oil.

In FIG. 1, in the case where the first connection pipe 42 is an inlet pipe, the coolant flows into the conduit member 15 via the first connection pipe 42. The coolant flows through the inner flow path 56 in the Z2 direction and flows into the cover inner space 78 from the second opening 56b. The coolant flows from the cover inner space 78 into each inner flow path (each slot 26) of the stator 12 and passes through the stator 12. As a result, the stator 12 is cooled. The coolant that has passed through the stator 12 is discharged to the outside of the rotating electric machine 10 via the second connection pipe 44. It should be noted that, in the case where the second connection pipe 44 is an inlet pipe, the coolant flows into the stator 12 via the second connection pipe 44, and then flows through the cover inner space 78, the conduit member 15, and the first connection pipe 42 in this order.

Next, a method of assembling the rotating electric machine 10 will be described.

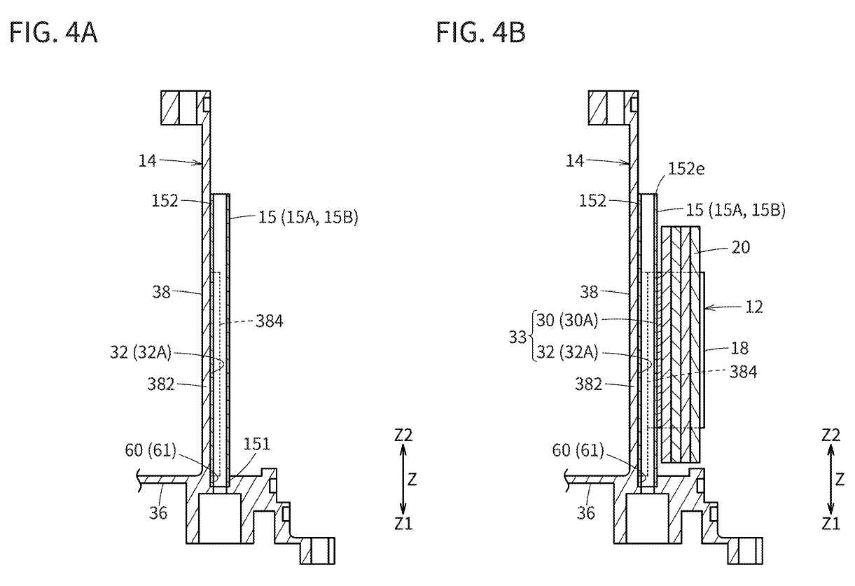

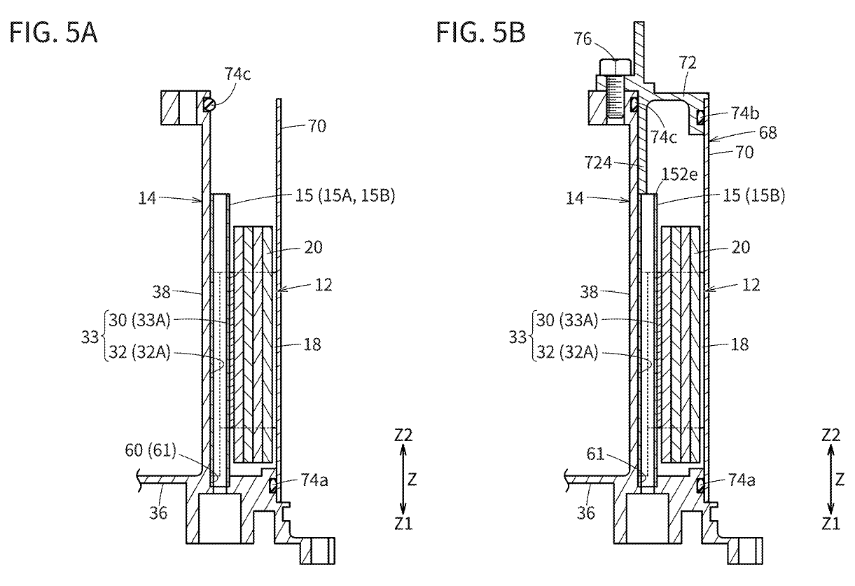

The method of assembling the rotating electric machine 10 includes a first mounting step, a second mounting step, and a cover mounting step. In FIGS. 4A to 5B, each step is performed with the Z1 direction of the stator holding member 14 facing downward.

As shown in FIG. 4A, in the first mounting step, the conduit members 15 are respectively mounted in the plurality of second semicircular grooves 32A provided in the stator holding member 14. In this case, the first end portions 151 of the first conduit members 15A are respectively press-fitted into the plurality of (two in the present embodiment) fixing holes 60. Further, the first end portions 151 of the second conduit members 15B are respectively inserted into the plurality of (four in the present embodiment) insertion holes 61, and the second conduit members 15B are placed in a temporarily assembled state. At this time, the second end portions 152 of the conduit members 15 are in a state of protruding further in the Z2 direction than the holding surface 384 (the outer peripheral surface of the large-diameter portion 382 in which the second semicircular grooves 32A are formed) of the stator holding member 14. It should be noted that either the press-fitting of the first conduit members 15A into the stator holding member 14 or the insertion of the second conduit members 15B into the stator holding member 14 may be performed first.

After the first mounting step, the second mounting step is performed. As shown in FIG. 4B, in the second mounting step, the stator 12 is mounted to the stator holding member 14 so as to face the stator holding member 14 in the radial direction. Specifically, the stator 12 is moved relative to the stator holding member 14 in the Z1 direction, and the conduit members 15 are respectively inserted into the plurality of first semicircular grooves 30A provided in the stator 12. In this case, the plurality of conduit members 15 can be used as guide members.

That is, when the stator 12 is moved relative to the stator holding member 14 in the Z1 direction, the first semicircular grooves 30A come into contact with the plurality of conduit members 15 before the stator 12 comes into contact with the holding surface 384. Two first conduit members 15A among the plurality of conduit members 15 are firmly fixed to the stator holding member 14 by being press-fitted into the fixing holes 60. Therefore, by the two first conduit members 15A being respectively inserted into the first semicircular grooves 30A, the axial alignment of the stator 12 and the stator holding member 14 is performed.

Further, since the first conduit members 15A each function as a so-called knock pin (dowel pin), positioning between the stator holding member 14 and the stator 12 in the circumferential direction can be performed. It should be noted that, although not shown in detail, rough phase alignment in the circumferential direction when the stator 12 is assembled to the stator holding member 14 can be performed by visually checking the position of a neutral point bus bar (not shown) provided in the stator 12.

Further, in the second mounting step, the stator 12 is fitted to the stator holding member 14 below the end surfaces 152e of the second end portions 152 of the conduit members 15. The fitting in this case may be press-fitting or shrink-fitting.

After the second mounting step, the cover mounting step is performed. As shown in FIG. 5A, in the cover mounting step, the seal member 74a on the lower side is attached to the holding base portion 36 of the stator holding member 14. Next, the sleeve 70 is mounted on the holding base portion 36 of the stator holding member 14. As a result, the stator 12 is surrounded by the sleeve 70. Next, the seal member 74c is attached to the holding body portion 38 of the stator holding member 14.

Next, as shown FIG. 5B, the seal member 74b is attached to the sleeve holder 72, and the sleeve holder 72 is mounted to the stator holding member 14. Next, the sleeve holder 72 is fixed to the stator holding member 14 by the fastening member 76. In this case, the conduit support portion 724 is in contact with the end surface 152e of each second conduit member 15B. As a result, the second conduit members 15B are supported by the sleeve holder 72. Thereafter, other components (the rotor 16 and the like) shown in FIG. 1 are assembled, and the assembly of the rotating electric machine 10 is completed.

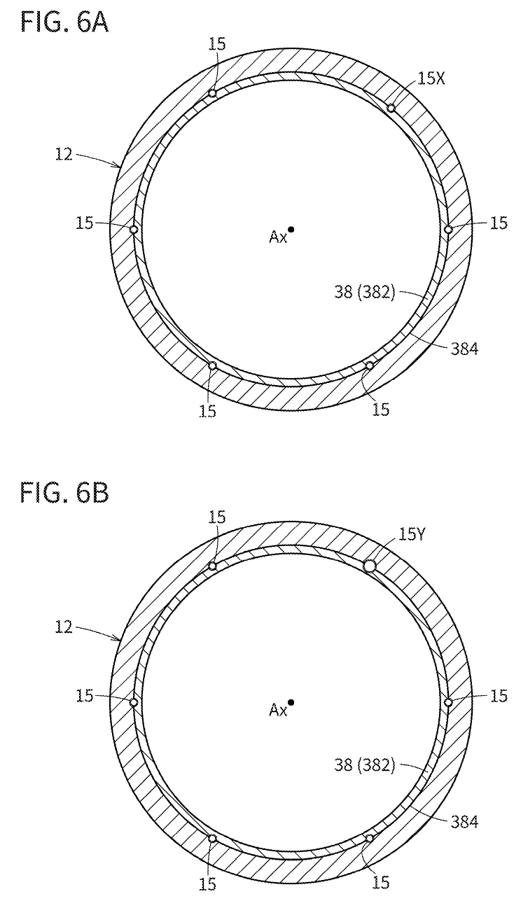

It should be noted that, in order to prevent the stator 12 from being erroneously assembled to the stator holding member 14, for example, as shown in FIG. 6A, only one of the plurality of conduit members 15 (a conduit member 15X) may be disposed at a different interval from the other conduit members 15. Alternatively, as shown FIG. 6B, only one of the plurality of conduit members 15 (a conduit member 15Y) may have a larger outer diameter than the other conduit members 15.

The present embodiment has the following effects.

As shown in FIG. 1, in the rotating electric machine 10, the conduit member 15 is disposed in the arrangement hole 33 formed by the first recess 30 provided in the stator 12 and the second recess 32 provided in the stator holding member 14. According to such a configuration, the conduit member 15 also serves as a member for performing positioning between the stator 12 and the stator holding member 14 in the circumferential direction, and therefore the number of components can be reduced and the positioning structure can be simplified.

As shown in FIG. 3, the conduit member 15 has a cylindrical shape, and each of the first recess 30 and the second recess 32 is a semicircular groove. According to such a configuration, the accuracy of positioning of the stator 12 with respect to the stator holding member 14 in the circumferential direction can be improved.

As shown in FIG. 1, at least two conduit members 15 (the first conduit members 15A) are respectively fixed by press-fitting to at least two fixing holes 60 provided in the stator holding member 14. According to such a configuration, the accuracy of positioning of the stator 12 with respect to the stator holding member 14 in the circumferential direction can be further improved. Further, since the conduit member 15 can also serve as a rotation stopper to prevent the stator 12 from rotating with respect to the stator holding member 14, a press-fitting load in the case where the stator 12 is fixed to the stator holding member 14 by press-fitting can be reduced.

Furthermore, the following effects may also occur concomitantly. As described above, since the accuracy of positioning of the stator 12 with respect to the stator holding member 14 in the circumferential direction is improved, it is not necessary to provide, in the electrical connection member 24, a long hole for absorbing the phase error in the circumferential direction. Since the conduit member 15 is disposed between the stator holding member 14 and the stator 12, the coolant flowing inside the conduit member 15 also contributes to cooling of the stator 12, and cooling efficiency is improved. Since the first recess 30 provided in the stator 12 is a part of the arrangement hole 33, a decrease in the volume of the stator 12 due to the provision of the arrangement hole 33 is suppressed as compared to a configuration in which a recess for forming the arrangement hole 33 is provided only in the stator 12. As a result, a decrease in the area of the magnetic circuit and an influence on the magnetic field distribution can be suppressed.

The second end portion 152 of the conduit member 15 protrudes further in the second direction (Z2 direction) than the end surface 18e of the stator core 18. According to such a configuration, when the stator 12 is assembled to the stator holding member 14, the stator 12 can be assembled using the conduit member 15 as a guide. Therefore, the accuracy of assembling the stator 12 to the stator holding member 14 can be improved. Further, since the first end portion 151 of the conduit member 15 is fixed to the fixing hole 60, the accuracy of assembling the stator 12 to the stator holding member 14 can be further improved.

The cover inner space 78 constituting a part of the flow path for the coolant is formed between the stator holding member 14, the stator 12, and the cover member 68. The second opening 56b formed in the second end portion 152 of the conduit member 15 communicates with the cover inner space 78. According to such a configuration, the configuration of the coolant flow path can be simplified.

As shown in FIG. 2, the plurality of conduit members 15 include the second conduit member 15B inserted into the insertion hole 61 provided in the stator holding member 14. The second conduit member 15B is supported in the axial direction by the cover member 68. According to such a configuration, the cover member 68 also serves to determine the position of the conduit member 15 in the axial direction, and therefore the number of components can be reduced.

As shown in FIG. 3, the plurality of conduit members 15 are provided at equal intervals in the circumferential direction of the stator 12. According to such a configuration, the stator 12 can be effectively cooled.

It should be noted that, although the rotating electric machine 10 shown in FIG. 1 is an outer rotor type rotating electric machine, the technique of the present disclosure is also applicable to an inner rotor type rotating electric machine.

The following supplementary notes are further disclosed in relation to the above-described embodiment.

### Supplementary Note 1

The rotating electric machine (10) of the present disclosure includes: the stator (12); the stator holding member (14) facing the stator in the radial direction and configured to hold the stator; and the conduit member (15) which is disposed between the stator and the stator holding member and through which a coolant for cooling the stator passes, wherein the first recess (30) is provided in the surface of the stator that faces the stator holding member, the second recess (32) facing the first recess is provided in the stator holding member, and the conduit member is disposed in the arrangement hole (33) formed by the first recess and the second recess. According to such a configuration, the conduit member also serves as a member for performing positioning between the stator and the stator holding member in the circumferential direction, and therefore the number of components can be reduced and the positioning structure can be simplified.

### Supplementary Note 2

In the rotating electric machine according to Supplementary Note 1, the conduit member may have a cylindrical shape, and each of the first recess and the second recess may be a semicircular groove. According to such a configuration, the accuracy of positioning of the stator with respect to the stator holding member in the circumferential direction can be improved.

### Supplementary Note 3

In the rotating electric machine according to Supplementary Note 2, at least two of the conduit members may be provided, and the at least two conduit members may be respectively fixed by press-fitting to at least two fixing holes (60) provided in the stator holding member. According to such a configuration, the accuracy of positioning of the stator with respect to the stator holding member can be further improved. Further, since the conduit member can also serve as a rotation stopper to prevent the stator from rotating with respect to the stator holding member, a press-fitting load in the case where the stator is fixed to the stator holding member by press-fitting can be reduced.

### Supplementary Note 4

In the rotating electric machine according to any one of Supplementary Notes 1 to 3, the conduit member may include the first end portion (151) and the second end portion (152), the first end portion may be an end portion in the first direction that is one direction extending along the axial direction of the stator, and the second end portion may be an end portion in the second direction opposite to the first direction and may protrude further in the second direction than the end surface (18e) of the stator core (18) provided in the stator. According to such a configuration, when the stator is assembled to the stator holding member, the stator can be assembled using the conduit member as a guide. Therefore, the accuracy of assembling the stator to the stator holding member can be improved.

### Supplementary Note 5

In the rotating electric machine according to Supplementary Note 4 as dependent on Supplementary Note 3, the first end portions may be respectively fixed to the fixing holes. According to such a configuration, the accuracy of assembling the stator to the stator holding member can be further improved.

### Supplementary Note 6

The rotating electric machine according to Supplementary Note 4 may further include the cover member (68) supported by the stator holding member, wherein the cover inner space (78) constituting a part of the flow path for the coolant may be formed between the stator holding member, the stator, and the cover member, and the opening formed in the second end portion of the conduit member may communicate with the cover inner space. According to such a configuration, the configuration of the coolant flow path can be simplified.

### Supplementary Note 7

In the rotating electric machine according to Supplementary Note 6, a plurality of the conduit members may be provided, the plurality of conduit members may include at least two first conduit members (15A) respectively press-fitted into at least two fixing holes provided in the stator holding member, and the second conduit member (15B) inserted into and supported by the insertion hole (61) provided in the stator holding member, and the second conduit member may be supported in the axial direction by the cover member. According to such a configuration, the cover member also serves to determine the position of the conduit member in the axial direction, and therefore the number of components can be reduced.

### Supplementary Note 8

In the rotating electric machine according to any one of Supplementary Notes 1 to 7, a plurality of the conduit members may be provided, and the plurality of conduit members may be provided at equal intervals in the circumferential direction of the stator. According to such a configuration, the stator can be effectively cooled.

### Supplementary Note 9

In the rotating electric machine according to any one of Supplementary Notes 1 to 8, the stator may include the electromagnetic coil (20) and the electrical connection member (24) connected to the electromagnetic coil, and the stator holding member may support the connector (48) to which the electrical connection member is connected.

### Supplementary Note 10

The method of assembling the rotating electric machine of the present disclosure is a method of assembling the rotating electric machine that includes the stator, the stator holding member configured to hold the stator, and at least two conduit members through which a coolant for cooling the stator passes, the method including: the first mounting step of respectively mounting the at least two conduit members in at least two second semicircular grooves (32A) provided in the peripheral surface of the stator holding member; and the second mounting step of, after the first mounting step, mounting the stator to the stator holding member in a manner so that the stator and the stator holding member face each other in the radial direction, wherein, in the first mounting step, the first end portions of the conduit members are respectively press-fitted into at least two fixing holes provided in the stator holding member, and in the second mounting step, the conduit members are respectively inserted into at least two first semicircular grooves (30A) provided in the peripheral surface of the stator, and the stator is fitted to the stator holding member below the end surfaces (152e) of the second end portions of the conduit members, the second end portions being located on a side opposite to the first end portions. According to this assembly method, each of the conduit members also serves as a member for performing positioning between the stator and the stator holding member in the circumferential direction, and therefore the number of components can be reduced and the positioning structure can be simplified. Since the conduit members are each disposed in the circular hole formed by the first semicircular groove and the second semicircular groove, the accuracy of positioning of the stator with respect to the stator holding member in the circumferential direction can be improved. Since the stator can be assembled to the stator holding member using each conduit member as a guide, the accuracy of assembling the stator to the stator holding member can be improved.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A rotating electric machine comprising:
a stator;
a stator holding member facing the stator in a radial direction and configured to hold the stator; and
a conduit member which is disposed between the stator and the stator holding member and through which a coolant for cooling the stator passes,
wherein a first recess is provided in a surface of the stator that faces the stator holding member,
a second recess facing the first recess is provided in the stator holding member, and
the conduit member is disposed in an arrangement hole formed by the first recess and the second recess.

2. The rotating electric machine according to claim 1, wherein
the conduit member has a cylindrical shape, and
each of the first recess and the second recess is a semicircular groove.

3. The rotating electric machine according to claim 2, wherein
at least two of the conduit members are provided, and
the at least two conduit members are respectively fixed by press-fitting to at least two fixing holes provided in the stator holding member.

4. The rotating electric machine according to claim 1, wherein
the conduit member includes a first end portion and a second end portion,
the first end portion is an end portion in a first direction that is one direction extending along an axial direction of the stator, and
the second end portion is an end portion in a second direction opposite to the first direction, and protrudes further in the second direction than an end surface of a stator core provided in the stator.

5. The rotating electric machine according to claim 3, wherein
the conduit members include first end portions and second end portions,
the first end portions are end portions in a first direction that is one direction extending along an axial direction of the stator,
the second end portions are end portions in a second direction opposite to the first direction, and protrude further in the second direction than an end surface of a stator core provided in the stator, and
the first end portions are respectively fixed to the fixing holes.

6. The rotating electric machine according to claim 4, further comprising a cover member supported by the stator holding member, wherein
a cover inner space that constitutes a part of a flow path for the coolant is formed between the stator holding member, the stator, and the cover member, and
an opening formed in the second end portion of the conduit member communicates with the cover inner space.

7. The rotating electric machine according to claim 6, wherein
a plurality of the conduit members are provided,
the plurality of conduit members include at least two first conduit members respectively press-fitted into at least two fixing holes provided in the stator holding member, and a second conduit member inserted into and supported by an insertion hole provided in the stator holding member, and
the second conduit member is supported in the axial direction by the cover member.

8. The rotating electric machine according to claim 6, wherein
a plurality of the conduit members are provided, and
the plurality of conduit members are provided at equal intervals in a circumferential direction of the stator.

9. The rotating electric machine according to claim 1, wherein
the stator includes an electromagnetic coil, and an electrical connection member connected to the electromagnetic coil, and
the stator holding member supports a connector to which the electrical connection member is connected.

10. A method of assembling a rotating electric machine that includes a stator, a stator holding member configured to hold the stator, and at least two conduit members through which a coolant for cooling the stator passes, the method comprising:
respectively mounting the at least two conduit members in at least two second semicircular grooves provided in a peripheral surface of the stator holding member; and
after mounting the conduit members, mounting the stator to the stator holding member in a manner so that the stator and the stator holding member face each other in a radial direction,
wherein, in the mounting of the conduit members, first end portions of the conduit members are respectively press-fitted into at least two fixing holes provided in the stator holding member, and
in the mounting of the stator, the conduit members are respectively inserted into at least two first semicircular grooves provided in a peripheral surface of the stator, and the stator is fitted to the stator holding member below end surfaces of second end portions of the conduit members, the second end portions being located on a side opposite to the first end portions.
